(19) United States
(12) Patent Application Publication
(10) Pub. No.: US 2020/0169090 A1
(43) Pub. Date: May 28, 2020

(54) ENERGY WAREHOUSE WITH ENERGY MANAGEMENT SYSTEM

(71) Applicants: el-Hadi Mohamed Aggoune, Brier, WA (US); Hani Awad Albalawi, Tabuk (SA); Amir Abdelfattah Ahmed Eisa, Kartoom (SD)

(72) Inventors: el-Hadi Mohamed Aggoune, Brier, WA (US); Hani Awad Albalawi, Tabuk (SA); Amir Abdelfattah Ahmed Eisa, Kartoom (SD)

(21) Appl. No.: 16/663,010

(22) Filed: Oct. 24, 2019

Related U.S. Application Data
(60) Provisional application No. 62/749,737, filed on Oct. 24, 2018.

(51) Int. Cl. H02J 3/32; H02J 3/38; G05B 13/02; H02J 13/00; G06Q 40/04; G06Q 50/06; H02J 3/00; G06Q 10/04

(52) U.S. Cl. CPC H02J 3/32; H02J 3/381; G05B 13/024; H02J 13/00006; G05B 13/0265; H02J 2203/20; G06Q 50/06; H02J 3/004; G06Q 10/04; H02J 2300/20; G06Q 40/04

(57) ABSTRACT

An energy warehouse comprising a plurality of energy storage units and switches, and connected to at least one microgrid and at least one bulk power system may be used in connection with an energy management system for the effectuation of power storage and power wheeling. Pursuant to a plurality of inputs transmitted from the energy storage units, microgrid(s), and bulk power system(s) to the energy management system, economical and sustainable power management between the energy warehouse, microgrid(s), and bulk power system(s) may be governed according to applicable operating scenarios as determined by an optimization procedure performed by said energy management system.

### CLAIM OF PRIORITY

The present application is a non-provisional application of a previously filed, currently pending provisional patent application having Ser. No. 62/749,737, filed on Oct. 24, 2018 which is herein incorporated by reference in its entirety.

### BACKGROUND OF THE INVENTION

### Field of the Invention

The present invention is directed to a large scale energy storage facility with power wheeling capabilities.

### Description of the Related Art

The demand on electrical energy has significantly increased in the last few decades due to global technological and economic developments. Accordingly, myriad power plants must be built to meet the increased demand, while simultaneously addressing problems such as congestion in the electrical networks that cause frequent blackouts and economic loss.

Moreover, the suitability of conventional fossil fuel based energy generation methods, such as those based on oil, coal, and natural gas, to address the aforementioned problems continues to dwindle due to their own problems. First, the limitation of supply and concentration of reserves in only a few countries raises both sustainability and security concerns. Second, there exists a global acknowledgment for the greenhouse effect, resulting global warming, and the accountability of fossil fuels for the emissions driving same.

Accordingly, the global push for the development of alternative and sustainable energy sources continues to grow. Such sustainable forms of energy development include, but are not limited to, solar, wind, and biomass energy. While there are many advantages in the development and production of such forms of sustainable energy, such as the reduction in reliance on fossil fuels, there remains problems as well.

One such problem relates to the stochastic nature of solar and wind based resources. Because the availability of these resources are randomly determined and cannot reliably be predicted, power based on these sources cannot be produced on demand and thus, power production based on these energy sources often causes imbalances between the power generation and power demand. Naturally, this imbalance has a propensity to grow over time and accordingly, generation of power according to these renewable sources may become even less stable and more challenging to control. Therefore, to make use of said energy sources on demand, said energy must be stored and adequately managed.

This problem may be exacerbated according to the current method of power distribution. Currently, microgrids, which are small scale self-supporting power networks, integrate the aforementioned renewable energy sources. However, because microgrids operate on a small scale, and because of the stochastic nature of renewable energy generation, microgrids have a limited ability to maintain and, to lesser extent, regulate frequency, voltage, and supporting restoration services after a fault. As a result, microgrids are often left to rely on power wheeling, which is the transportation of electric energy to an electrical load outside the grid boundaries, from an interconnected bulk power system in times of high energy demand and/or low energy generation.

Although said power wheeling with a bulk power system operates to stabilize the imbalance between power generation and power demand for the microgrids, bulk power systems have their own problems. Typically, bulk power systems heavily rely on fossil fuels for power generation. Of course given the links between fossil fuels and global warming, such reliance may be problematic. Further, bulk power systems often necessitate costly and continuous maintenance due to their transmission systems and related equipment.

Accordingly, there exists a need to diminish the reliance of microgrids on bulk power systems. In doing so, the reliance on fossil fuels may be greatly reduced as the integration of renewable resources may increase, and the additional maintenance costs associated with bulk power systems may likewise be reduced. Such a solution should aim not only to buffer the difference between power generation and demand for microgrids to stabilize the electrical power transmission from renewable resources, but also aim to provide other benefits, such as suppressing frequency abnormalities, mitigate congestion, and increase efficiency. Moreover, such a solution should further aim to assist microgrids in load leveling and peak shaving, the availability of spinning reserve, and general power quality management controls.

Furthermore, any solution will need to address and improve upon the financial aspects pertaining to the transmission of energy in order to function as an economical and sustainable operation. Such financial aspects may include, without limitation, the provision of affordable clean energy from renewable and sustainable sources, the reduction of the need for the installation of new energy generation infrastructure, and the reduction of transmission and distribution losses stemming from congestion, outages, anomalies, and load curtailing or shedding.

### SUMMARY OF THE INVENTION

Some or all of the above needs and/or problems may be addressed by various embodiments of the disclosure. Particularly, certain embodiments of the present invention may include a self-standing and self-contained energy warehouse, designed for the large scale storage of energy, interconnected between at least one microgrid and at least one bulk power system for the transfer of energy there between. Further, disposed in the energy warehouse may be an energy management for oversight and regulation of the quality attributes and power quality management controls of the energy storage units, the power forecasts of the at least one microgrid and the at least one bulk power system, and the coordination of power wheeling between the microgrid(s) and bulk power system(s).

At least one embodiment of the energy warehouse according to the disclosure comprises a physical space at an environmental location, herein referred to as an energy reservoir, functioning as a repository for a plurality of energy storage units, hereinafter referred to as modules. The modules may comprise large scale, modular energy storage systems, designed to individually store energy but function as a complete unit. The plurality of modules may, in some embodiments, further comprise a heterogeneous array of modules, wherein each module may comprise an energy storage system configured to store energy according to a variety of different energy storage techniques, technologies, capacities, and capabilities.

For example, the energy storage system for each module comprising the heterogeneous array thereof may utilize a different type of energy storage technology, whether conventional, unconventional, experimental, or hereafter discovered. Such energy storage technologies may include, but are not limited to the following energy storage categories: electrochemical energy storage, chemical energy storage, high temperature thermal energy storage, electromagnetic energy storage, and mechanical energy storage. Although selection of appropriate energy storage technologies for the construction of a heterogeneous array of modules is highly dependent on the specific requirements and costs associated with a given project, each of these types of energy storage technologies must, at the very least, be applicable for large scale, high energy storage such that it may pragmatically be applied at the grid level. Accordingly, each type of energy storage technique will be briefly discussed herein, so as to illustrate practical energy storage technologies within each category.

Electrochemical energy storage typically comprises batteries converting chemical energy contained in its active materials into electric energy by an electrochemical oxidation-reduction reverse reaction. Electrochemical applications in accordance with at least one embodiment of the present invention may include conventional battery technologies, such as lead acid batteries, nickel-cadmium batteries, and lithium-ion batteries, high temperature batteries, such as sodium sulfur batteries and sodium nickel chloride batteries, and flow batteries, such as redox flow batteries and hybrid flow batteries.

Chemical energy storage, as used herein, constitutes renewable generated chemicals, such as hydrogen and synthetic natural gas, each of which are appropriately used in large-scale applications. Said aforementioned renewable generated chemicals have much greater energy density than the energy density of current battery technologies and accordingly, can be stored for long periods of time, thereby making them an effective choice for the energy storage modules of at least one embodiment of the present invention.

High temperature thermal energy storage techniques function by stocking thermal energy through the heating or cooling of a storage medium for use at a later time. While typically used at lower temperatures, use at higher temperatures is a possible technology for energy storage, particularly due to the possibility of greater efficiency and benefits in connection with solar thermal power generation.

Electromagnetic energy storage consists, as applied in at least one embodiment of the present invention, of at least capacitors, where energy is stored in an electric field between two charged electrodes, and superconducting magnetic energy storage devices, where energy is stored in a magnetic field generated by a current running through a superconducting wire. The aforementioned techniques may be applicable as energy storage modules of the present invention due to their high power density, high efficiency, and low amounts of degradation.

Mechanical energy storage technologies may include pumped hydro storage, compressed air energy storage, and flywheels. At this moment, the aforementioned energy storage techniques remain experimental, with only pumped hydro storage currently finding applications at the grid level. However, by converting energy between kinetic and potential energy, mechanical energy storage techniques could also be used in accordance with at least one embodiment of the present invention.

In addition to at least one storage device, each module may further comprise a power converter, or rectifier, which is used to convert an alternating current into a direct current, thereby facilitating the transfer of electrical energy to and from the modules. Further, each module may also contain a control system, at least for controlling the amount of energy stored within the module's storage device and monitoring certain attributes such as the operability status and power quality management controls of the modules.

The energy warehouse may also contain at least one switch, and in some embodiments, may contain at least two switches. The switch(es) may be used to connect the plurality of modules with the microgrids and bulk power systems. Accordingly, during the power wheeling process, the switches may be used to direct power transfer either to or from the microgrids and bulk power systems respectively.

In at least one embodiment, disposed in connection with the energy warehouse, is an energy management system. The energy management system functions to collect information from the plurality of modules, the microgrids, and the bulk power systems, perform analyses, control various functionalities, and determine the optimal unit commitment and economic dispatch of the currently available energy stored within the plurality of modules in order to meet the variety of conditions and objectives imposed thereon.

Accordingly, it may be understood that the energy management system may exercise control over the operability status, or “ilities,” and power quality management controls of the modules, and the power wheeling between the energy warehouse and the microgrids and bulk power systems. Although the energy management system may perform each of these functions differently depending on the various factors associated with the given energy warehouse at that state of time, there do remain some common objectives which may perpetuate throughout at least some embodiments of the present invention including, but not limited to, satisfying the power transactions between the energy warehouse and the microgrids and bulk power systems in an optimal way according to an agreed upon schedule. Likewise, common conditions sought to be satisfied in at least some embodiments of the present invention include, but are not limited to, power quality and security constraints.

As stated previously, to meet these objectives and conditions, the energy management system must collect all pertinent data from the modules, microgrids, and bulk power systems in order to effectively perform a multi-stage optimization designed to determine the optimal unit commitment and dispatch of energy storage. Said data inputs may include: power forecasts, including power generation and power demand, of the energy warehouse, microgrids, and bulk power systems; ilities of the modules, including, but not limited to, the state of charge, operating limits, security constraints, and reliability constraints; the interconnections between the energy warehouse and the microgrids and bulk power systems; and the energy price schedule.

According to the aforementioned inputs, the energy management system may effectively, in at least one embodiment, generate a report including, without limitation, the power to purchase and/or sell energy, the schedules and timelines thereof, and the associated prices and fees. Said report may be communicated to an authority or operator, such as the energy market arbiter, to then enter the energy bidding process according to the instruction disposed therein. Moreover, the energy management system may further use said inputs to oversee and control the power quality management controls of the plurality of modules, including, without limitation, the voltage, stability, power quality, and outgoing power of the plurality of modules, both individually and collectively.

As previously stated, the energy management system may perform a multi-stage optimization according to the collected information designed to determine the optimal unit commitment and dispatch of energy storage. Said multi-stage optimization may comprise a plurality of different tasks and functions including, without limitation, forecasting, optimization, and decision making, as discussed herein.

Forecasting is an online operation contributing to energy generation tracking and energy storage, wherein the relevant data is made available in time for optimization tasks. Forecasting may rely, in at least one embodiment, on a recurrent neural network due to its practical and effective application for short term forecasting wherein the data contains a temporal dependency.

Optimization of the operating cost of the energy warehouse is an important task as it pertains to the sustainability of the energy warehouse. Given the need for large amounts of data to reach an acceptable solution within a reasonable time frame, genetic algorithms, which are global search techniques based on mechanisms observed in natural biological systems, may be effectively used in at least one embodiment of the present invention due to their effectiveness at dealing with stochastic problems.

Decision making, as it pertains to power wheeling and energy trading, must be both successful and efficient. Accordingly, an integration of fuzzy logic, where truth values may comprise any real number between, and including, 0 and 1, and expert systems, a decision-making computer system emulating the decision making of humans through implementation of “if-then” rules, may be used in at least one embodiment to meet the often antagonistic demands of producing and/or buying and storing power.

Lastly, because the cost of operating the energy warehouse is closely linked to the sustainability thereof, the energy management system must also focus the multi-stage optimization on the power management of the plurality of modules and the associated costs of operating said devices. As will be discussed later, said determinations may also be used to determine a variety of operating scenarios which may also drive the determinations made by the energy management system and the subsequent control over the modules and energy transmission thereto and therefrom.

In this manner, the energy warehouse of the disclosure, in conjunction with the energy management system thereby disposed, may play different roles as an intermediary between the microgrid(s) and the bulk power system(s). For example, with respect to the microgrid(s), the energy warehouse may play the role of an infinite bus or a bulk power system, by providing a stable and constant source of additional energy. In contrast, with respect to the bulk power system(s), the energy warehouse may instead play the role of a reservoir for the receipt and storage of energy.

Accordingly, the energy warehouse and energy management system as herein disclosed may effectively solve at least some, if not all, of the previously mentioned problems as microgrids will experience benefits in terms of reliability, security, and stability, especially during periods of fluctuating generation and demand. It may be understood solutions to said problems may include, without limitation, the integration of more renewable energy and subsequent decrease in emissions, a reduction in transmission and distribution losses, enhanced stability in the face of electrical outages, and a reduction in the need for installation of new power generation infrastructure.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 depicts a systematic diagram of an embodiment of the disclosure pertaining to the interconnections between the energy warehouse, microgrids, and bulk power systems.

FIG. 2 depicts a systematic diagram of an embodiment of the disclosure pertaining to the interconnections between the energy management system, the plurality of modules, and the switches.

FIG. 3 depicts a further embodiment of the present invention directed to an energy warehouse and interconnected energy management system.

FIG. 4 depicts an exemplary flow diagram of a process, according to at least one embodiment, to be used by the energy management system, for controlling the functionality of the energy warehouse and the transmission of energy to and/or from the microgrids and bulk power systems.

FIG. 5 depicts an exemplary flow diagram for the determination of several operating scenarios of an embodiment of the present invention.

FIG. 6 depicts an exemplary flow diagram for the determination of several operating scenarios of an embodiment of the present invention.

### DETAILED DESCRIPTION OF THE PREFERRED EMBODIMENT

Illustrative embodiments of the disclosure will now be described more fully hereinafter with reference to the accompanying drawings in which some, but not all, embodiments of the disclosure are shown. The disclosure may be embodied in many different forms and should not be construed as limited to the embodiments set forth herein; rather, these embodiments are provided so this disclosure will satisfy applicable legal requirements.

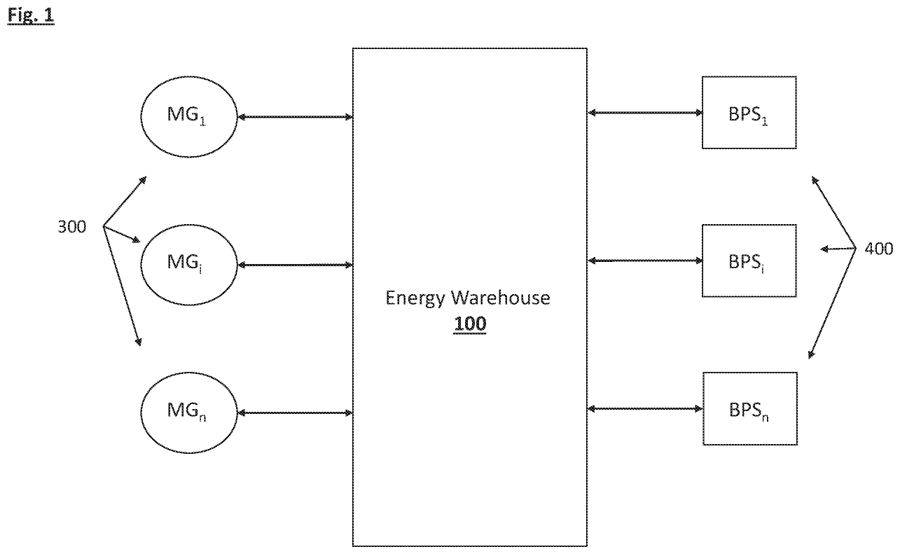

With reference to FIG. 1, depicted therein is at least one embodiment of an energy warehouse as disclosed herein. As can be seen, the energy warehouse 100 (“EW”) may be interconnected with a plurality of microgrids (“MG”) 300 and bulk power systems (“BPS”) 400. Further, as may be appreciated, the energy warehouse 100 may be interconnected with a plurality of microgrids 300 and only one bulk power system 400, or vice versa.

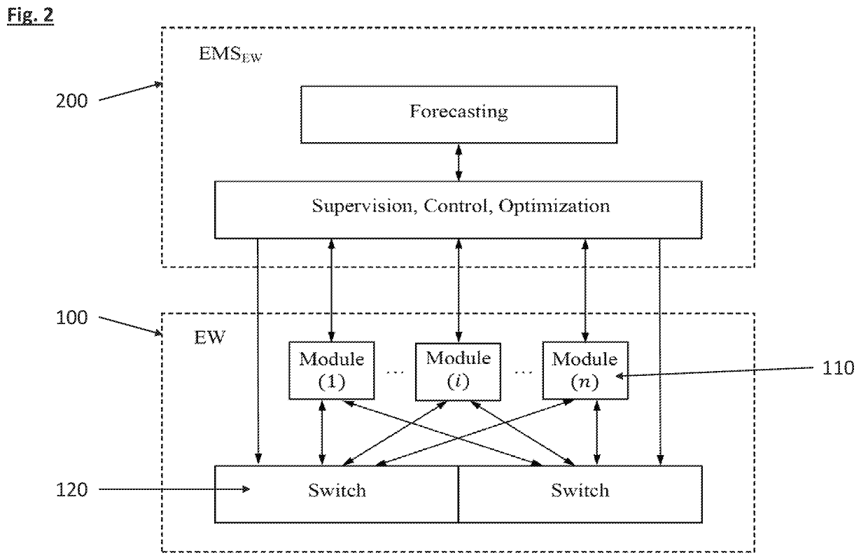

Further, depicted in FIG. 2 is at least one embodiment of the disclosure. As depicted therein, the energy warehouse 100 may comprise a plurality of modules 110 and two switches 120. Further, the energy warehouse 100 may comprise an energy management system 200 (“EMSEw”) disposed in connection with the modules 110 and switches 120 for data transmission and operability control. The energy management system 200 may perform a variety of functions, including at least forecasting, dependent upon the power generation and demand of any microgrids 300 and bulk power systems 400 connected to the energy warehouse 100, and the supervision, control, and optimization of the modules 110 and switches 120 of energy warehouse 100.

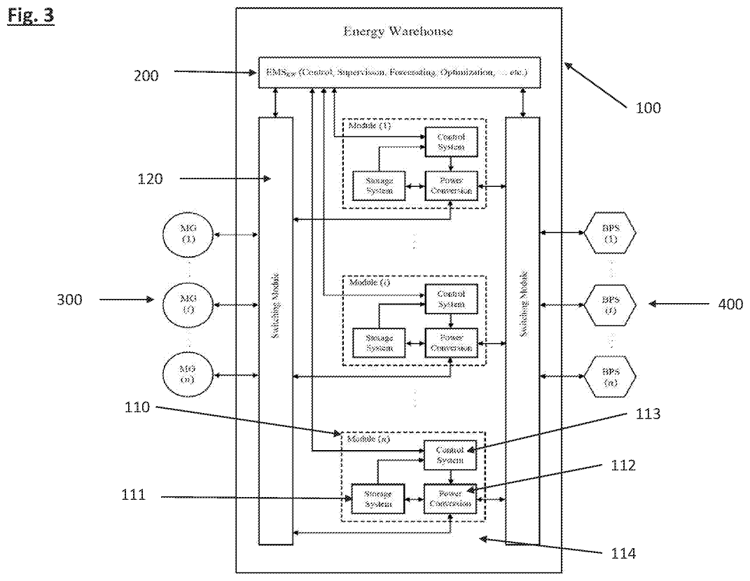

With reference to FIG. 3, depicted therein is a further embodiment of the disclosure. As can be seen, the energy warehouse 100 may comprise an energy reservoir 114, such as a physical space containing a plurality of modules 110 and two switches 120. The switches 120 may be connected to a plurality of microgrids 300 and a plurality of bulk power systems 400 for the transmission of both power and data. Accordingly, the switches 120 are used to route power in a manner ensuring reliability of connection and power transfer both to and from the plurality of microgrids 300 and the plurality of bulk power systems 400.

Further, as can be seen, the plurality of modules 110 may each comprise an energy storage system 111, a power converter 112, such as a rectifier for conversion of an alternating current into a direct current, and a control system 113. The control system 113 may be used, for example, for the monitoring, control, and analysis of the energy storage system 111 disposed within a given module 110, and may assess a variety of factors indicative of the energy storage system's 111 functional status. For example, the control system 113 may monitor the operability status, or “ilities,” of the energy storage system 111, which include, without limitation, the state of charge, operating limits, security constraints, and reliability constraints thereof. Likewise, the control system 113 may also monitor and exercise control over the power quality management controls of the energy storage system 111, including, without limitation, the voltage, stability, power quality, incoming and outgoing power, and storage efficiency of the energy storage system 111. Accordingly, the control system 113 may oversee the short and long-term operation of the energy storage system 111, thus ensuring an efficient and lengthy life cycle of the module 110.

Further depicted in FIG. 3, it can be seen that an energy management system 200 may be interconnected with both the plurality of modules 110 and the switches 120. The energy management system 200 may receive inputs 210, such as information, from the control systems 113 of the plurality of modules 110, including, without limitation, the ilities and power management controls of the energy storage system 111. Further, the energy management system 200 may, through the switches 120, receive inputs, such as information, from the plurality of microgrids 300 and the plurality of bulk power systems 400, including, without limitation, the power forecasts for each of the microgrids 300 and bulk power systems 400. The power forecasts may comprise, for example, the current power status, the power generation, power demand, and energy price schedule of each of the microgrids 300 and bulk power systems 400.

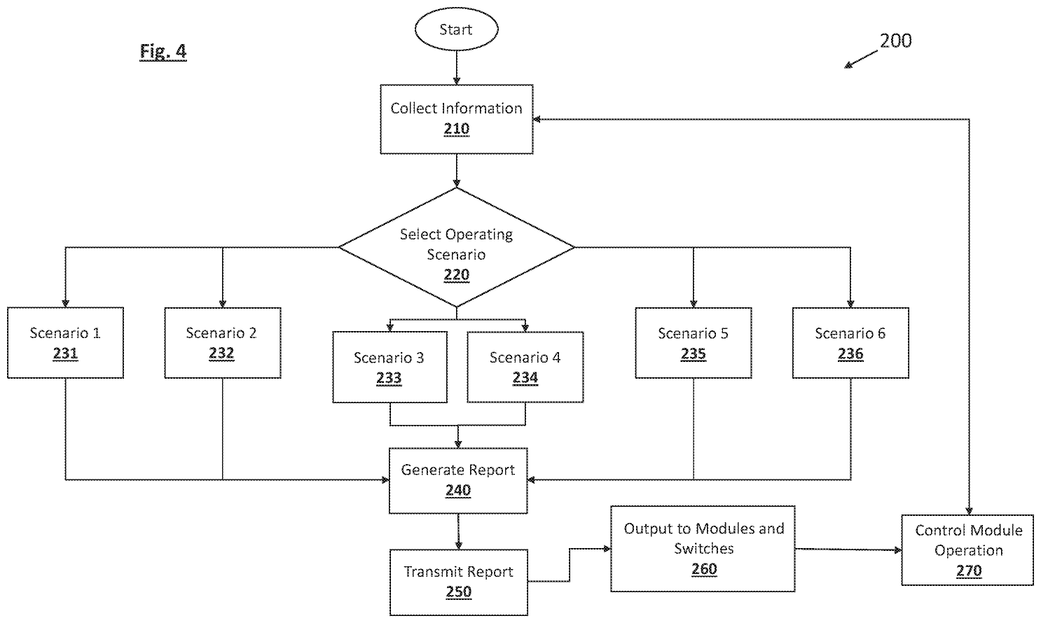

With reference to FIG. 4, depicted therein is an embodiment of an exemplary process through which the energy management system 200 may operate. As can be seen, and as previously stated, the energy management system 200 may collect inputs 210, such as information, from the plurality of modules 110, microgrids, 300, and bulk power systems 400. After collecting said information 210, the energy management system 200 may then select the correct operating scenario 220 under which it will operate. Selection of the correct operating scenario 220 will accordingly define the optimal unit commitment and economic dispatch of the available energy disposed within the plurality of modules 110, commensurate with the relevant objectives and conditions stipulated by the given energy warehouse 100.

To determine the correct operating scenario 220, the energy management system may perform a multi-stage optimization according to the collected information 210. Performance of the multi-stage optimization may require implementation of a variety of tools such as forecasting, optimization, and decision-making, as previously discussed.

Further, the energy management system 200 must account for a cost function associated with the given energy warehouse 100, through the selection of a specific operating scenario 220, in order to determine the optimal operation of the energy warehouse 100. An exemplary cost function for determining the operating scenario 220 of an energy warehouse will be discussed herein.

First, because the energy warehouse may be comprised of a plurality modules 110, and because said plurality of modules 110 may comprise a heterogenous array of modules wherein each energy storage system 111 may utilize a different energy storage technology or technique for storing energy, each module 110 may be considered as a large and independent battery or battery equivalent. Accordingly, the complex power of each module, or battery as denoted by subscript “B”, may be written as:

S_{B}(t)=P_{B}(t)+jQ_{B}(t) (1)

Where:

S_{B} is the complex power at time t;

P_{B} is the real power at time t, such that P_{B} is positive when the energy storage system 111 is charging and is negative when the energy storage system 111 is discharging; and

Q_{B} is the reactive power at time t.

Accordingly, the cost of operating a device at a given time instant “t” can be formulated as follows:

min C_{B}(P_{B}(t))=α_{B}P_{B}(t)²+β_{B} (2)

Subject to:

E_{B}(t+Δt)=E_{B}(t)+P_{B}(t)Δt (3)

P_{B}(t)²+Q_{B}(t)²«S_{B}² (4)

P_{B}^{min}≤P_{B}(t)≤P_{B}^{max} (5)

E_{B}^{min}≤E_{B}(t)≤E_{B}^{max} (6)

Where:

P_{B}^{min}, P_{B}^{max} are the minimum and maximum charging rates;

E_{B}^{min}, E_{B}^{max} are the minimum and maximum allowed energy stored in the energy storage system;

C_{B}(P_{B}(t)) is the cost function; and

α_{B},β_{B} are constant parameters.

Further, the composite cost function for the energy warehouse 100 will accordingly be a linear combination of the storage device cost functions. Thus, the overall cost function to optimize the energy warehouse 100 will be:

min Σ_{T}(C_{EW}P_{EW}(t)+C_{BPS}P_{BPS}(t)+C_{MG}P_{MG}(t)) (7)

Where C_{EW}, C_{BPS}, and C_{MG} are the costs of power associated with the energy warehouse 100, bulk power system(s) 400, and microgrid(s) 300. In the case of the bulk power system(s) 400 and the microgrid(s) 300, the costs C_{BPS} and C_{MG} may be either positive or negative dependent on whether the energy warehouse 100 is buying or selling according to the operating scenarios hereinafter described.

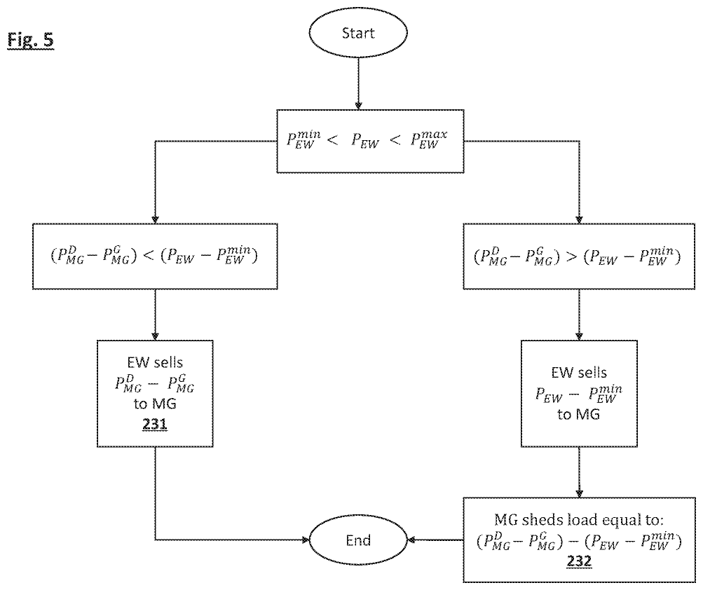

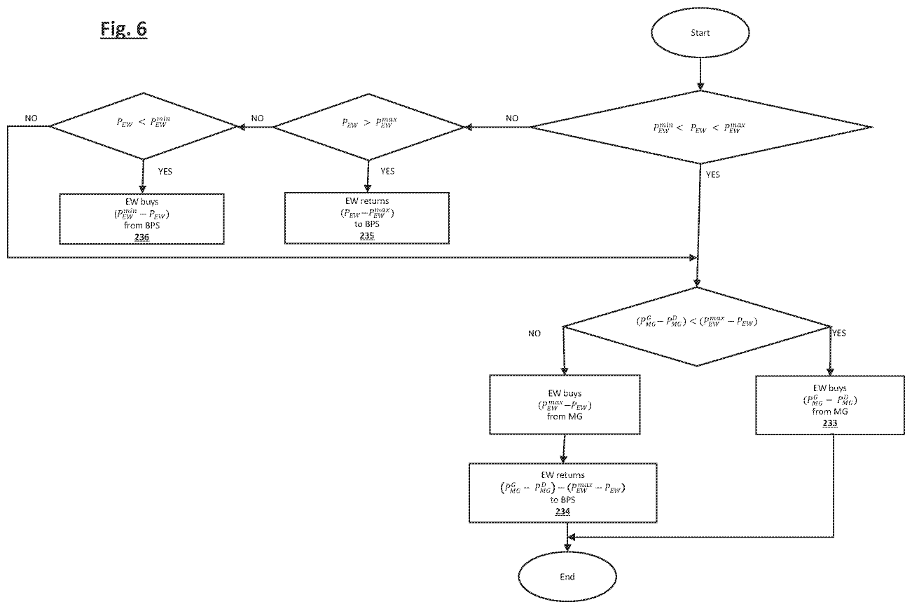

At least one embodiment of the disclosure may utilize the aforementioned cost function with the following rules to determine the operating scenario 220 of the energy warehouse 100, as shown in FIG. 5, depicting operating scenarios 1 (231) and 2 (232) therein, and FIG. 6, depicting scenarios 3 (233), 4 (234), 5 (235) and 6 (236) therein. Although the energy warehouse 100 may be connected to a plurality of microgrids 300 and bulk power systems 400, the operating scenarios described herein are exemplary of an embodiment wherein the energy warehouse 100 is connected to only one microgrid 300 and one bulk power system 400. Each operating scenario will now be briefly discussed below, where:

P_{MG}^{G} is the power generation of the microgrid(s) 300;

P_{MG}^{D} is the power demand of the microgrid(s) 300;

P_{EW}^{max} is the maximum allowable power of the energy warehouse 100;

P_{EW}^{min} is the minimum allowable power of the energy warehouse 100;

P_{EW} is the power available at the energy warehouse 100 at a given instant in time;

P_{BPS}^{G} is the power generation of the bulk power system(s) 400; and

P_{MG}^{D} is the power demand of the bulk power system(s) 400.

### Operating Scenario 1 (231):

In operating scenario 1 (231), as depicted in FIG. 5, the energy warehouse 100 will sell power to the microgrid 300 if:

P_{EW}^{min}<P_{EW}<P_{EW}^{max} and (P_{MG}^{D}−P_{MG}^{G})<(P_{EW}−P_{EW}^{min})

In such a case, the energy warehouse 100 will sell P_{MG}^{D}−P_{MG}^{G} to the microgrid 300.

### Operating Scenario 2 (232):

In operating scenario 2 (232), as depicted in FIG. 5, the energy warehouse 100 cannot buy power from the bulk power system 400. Accordingly, the energy warehouse 100 will sell power to the microgrid 300 and the microgrid 300 will shed a load, subject to a penalty fee payable by the energy warehouse 100. Operating scenario 2 (232) will occur where:

P_{EW}^{min}<P_{EW}<P_{EW}^{max} and (P_{MG}^{D}−P_{MG}^{G})>(P_{EW}−P_{EW}^{min})

In such a case, the energy warehouse 100 will sell P_{EW}−P_{EW}^{min} to the microgrid 300 and the microgrid 300 will subsequently shed a load equivalent to (P_{MG}^{D}−P_{MG}^{G})−(P_{EW}−P_{EW}^{min}), subject to said penalty fee.

### Operating Scenario 3 (233):

In operating scenario 3 (233), as depicted in FIG. 6, the energy warehouse will purchase power from the microgrid 300 if:

P_{EW}^{min}<P_{EW}<P_{EW}^{max} and (P_{MG}^{G}−P_{MG}^{D})<(P_{EW}^{max}−P_{EW})

In such a case, the energy warehouse 100 will purchase P_{MG}^{G}−P_{MG}^{D} from the microgrid 300.

### Operating Scenario 4 (234):

In operating scenario 4 (234), as depicted in FIG. 6, the energy warehouse 100 will purchase power from the microgrid 300 and return power to the bulk power system 400, subject to a restocking fee payable by the energy warehouse 100 if:

P_{EW}^{min}<P_{EW}<P_{EW}^{max} and (P_{MG}^{G}−P_{MG}^{D})>(P_{EW}^{max}−P_{EW})

In such a case, then the energy warehouse 100 will purchase P_{EW}^{max}−P_{EW} from the microgrid 300 and return (P_{MG}^{G}−P_{MG}^{D})−(P_{EW}^{max}−P_{EW}) to the bulk power system 400, subject to said restocking fee.

### Operating Scenario 5 (235):

In operating scenario 5 (235), depicted in FIG. 6, the power available at the energy warehouse 100 at a given instant in time is greater than the maximum power capacity of the energy warehouse 100. Accordingly, the energy warehouse 100 will return the excess energy P_{EW}−P_{EW}^{max} to the bulk power system 400, in some cases invoking a restocking fee payable by the energy warehouse 100.

### Operating Scenario 6 (236):

In operating scenario 6 (236), depicted in FIG. 6, the power available at the energy warehouse 100 at a given instant in time is less than the minimum power requirement at the energy warehouse 100. Accordingly, the energy warehouse 100 will purchase the necessary energy P_{EW}^{min}−P_{EW} from the bulk power system 400.

Accordingly, as can be seen from the aforementioned operating scenarios, the responsibilities between the energy warehouse 100 and microgrid(s) 300 and the responsibilities between the energy warehouse 100 and the bulk power system(s) 400 are different in order to maintain an economical and sustainable operation of the energy warehouse 100.

Returning to FIG. 4, it can be seen that after the selection of an operating scenario 220, the energy management system 200 will generate a report 240. The report 240 may comprise a plurality of outputs, including without limitation, information regarding the amount of power to purchase or sell, the associated schedules and timelines, and the appropriate prices and fees. Further, the report may then be transmitted 250 to an operator, such as an energy market arbiter, with instructions to enter the bidding contest according to the details of the report 240.

Subsequent to the aforementioned process, the energy management system 200 may output 260 to the modules 110 and the switches 120 instructions in accordance with the report 240. Such instructions may comprise, for example, instructions to direct power either to or from the microgrids 300 and bulk power systems 400.

Finally, both subsequent to and throughout the aforementioned process, it should be noted the energy management system 200 may control the operation 270 of the modules 110. Such control may relate to short term power quality management controls, such as the voltage, stability, and power quality of the energy storage systems 111 and the incoming or outgoing power at the switches 120. Additionally, said control may relate to the long term power quality management controls, such as the storage efficiency and life cycle of the energy storage systems 111.

Accordingly, it can be seen that the energy warehouse and energy management system as herein disclosed may effectively solve at least some, if not all, of the previously mentioned problems. Solutions to said problems may include, without limitation, the integration of more renewable energy and subsequent decrease in emissions, a reduction in transmission and distribution losses, enhanced stability in the face of electrical outages, and a reduction in the need for installation of new power generation infrastructure.

It can be understood that the present invention is not limited to the embodiments described above, but may encompass any and all embodiments within the scope of the following claims.

What is claimed is:

1. An energy warehouse for providing reliable and sustainable power, said energy warehouse comprising:
an energy reservoir comprising a plurality of modules, said modules each comprising at least one energy storage system, at least one power converter, and at least one control system;
said energy reservoir further comprising at least two switches;
said energy reservoir in power and data transfer relation with at least one microgrid and at least one bulk power system through said at least two switches; and
an energy management system in input-output relation with said at least one control system in said plurality of modules, said energy management system disposed to:
a) collect information from said at least one control system in said plurality of modules;
b) process said information according to an optimization procedure; and
c) manage and control said plurality of modules.

2. The energy warehouse of claim 1, wherein said information collected by said energy management system comprises at least the ilities of said plurality of modules.

3. The energy warehouse of claim 1, wherein said energy management system is further connected in input-output relation with said at least one switch, such that said energy management system is configured to collect information from the at least one microgrid and the at least one bulk power system through said at least one switch.

4. The energy warehouse of claim 3, wherein said information collected by said energy management system comprises at least the power forecasts of the at least one microgrid and the at least one bulk power system.

5. The energy warehouse of claim 4, further comprising said energy management system processing said information according to at least an optimization procedure to determine an operating scenario.

6. The energy warehouse of claim 5, wherein said energy management system transmits a report to at least one operator after processing said information and determining an operating scenario.

7. The energy warehouse of claim 1, wherein said plurality of modules comprises an at least partially heterogeneous array of modules, each module comprising at least one energy storage system disposed to store energy according to at least one of a plurality of large-scale energy storage techniques.

8. The energy warehouse of claim 1, wherein said energy management system manages and controls said plurality of modules by regulating at least the power quality management controls of said plurality of modules.

9. An energy warehouse for facilitating power wheeling, said energy warehouse comprising:
an energy reservoir comprising a plurality of modules, said plurality of modules each comprising at least one energy storage system, at least one power converter, and at least one control system;
said energy reservoir further comprising at least one switch;
said energy reservoir in power and data transfer connection with at least one microgrid and at least one bulk power system through said at least one switch; and
an energy management system in input-output relation with said at least one switch and said at least one control system in said plurality of modules, said energy management system structured and disposed to:
a) collect information from the at least one microgrid and the at least one bulk power system through said at least one switch;
b) process said information according to an optimization procedure to determine an operating scenario; and
c) transmit a report to an operator.

10. The energy warehouse of claim 9, wherein said information collected by said energy management system comprises at least the power forecasts of the at least one microgrid and the at least one bulk power system.

11. The energy warehouse of claim 9, wherein said report comprises at least instructions to purchase or sell energy to the at least one microgrid and the at least one bulk power system.

12. The energy warehouse of claim 9, wherein said information collected by said energy management system comprises at least the ilities and power quality management controls of said plurality of modules.

13. The energy warehouse of claim 12, wherein said energy management system is configured to manage and control said plurality of modules by regulating at least said power quality management controls of said plurality of modules.

14. The energy warehouse of claim 12, wherein said plurality of modules comprises an at least partially heterogeneous array of modules, each module comprising at least one energy storage system disposed to store energy according to at least one of a plurality of large-scale energy storage techniques.

15. The energy warehouse of claim 9, wherein said optimization procedure comprises forecasting tasks, optimization tasks, and decision-making tasks.

16. A method for managing power wheeling between an energy warehouse and a plurality of microgrids and a plurality of bulk power systems, performed by an energy management system, said method comprising:
collecting information with an energy management system from a plurality of modules and at least one switch, the plurality of modules and at least one switch disposed within an energy reservoir;
collecting information with the energy management system from at least one microgrid and at least one bulk power system, the at least one microgrid and the at least one bulk power system connected to the energy reservoir through the at least one switch;
selecting an operating scenario according to an optimization procedure;
generating a report according to the operating scenario;
transmitting the report to an operator;
communicating the desired function to the plurality of modules and at least two switches; and
controlling the operation of the plurality of modules for effectuating power wheeling.

17. The method of claim 16, wherein the energy management system is collecting information comprising at least the ilities and power quality management controls of the plurality of modules, and the power forecasts of the at least one microgrid and the at least one bulk power system.

18. The method of claim 17, wherein the report comprises the power to sell and purchase energy and the associated schedule and costs thereof.

19. The method of claim 17, wherein the energy management system manages and controls the plurality of modules by regulating the power quality management controls of the plurality of modules.

20. The method of claim 16, wherein the plurality of modules comprises a heterogenous array of modules, each module comprising at least one energy storage system disposed to store energy according to at least one of a plurality of large-scale energy storage techniques.
